(19) United States
(12) Patent Application Publication
(10) Pub. No.: US 2012/0045168 A1
(43) Pub. Date: Feb. 23, 2012

(54) FLEXIBLE OPTOELECTRONIC INTERCONNECTION BOARD AND FLEXIBLE OPTOELECTRONIC INTERCONNECTION MODULE

(75) Inventors: Hiroshi Uemura, Yokohama-shi (JP); Hideto Furuyama, Yokohama-shi (JP)

(73) Assignee: KABUSHIKI KAISHA TOSHIBA, Tokyo (JP)

(21) Appl. No.: 13/207,615

(22) Filed: Aug. 11, 2011

(30) Foreign Application Priority Data
Aug. 19, 2010 (JP) 2010-184120

(51) Int. Cl. G02B 6/12

(52) U.S. Cl. 385/14

(57) ABSTRACT

According to one embodiment, a flexible optoelectronic interconnection board includes a flexible electrical wiring board having electrical wires, reinforcing boards mounted on the flexible electrical wiring board and having flexibility lower than that of the flexible electrical wiring board, and a flexible optical interconnection board mounted on the flexible electrical wiring board and having optical interconnection lines. The flexible electrical wiring board includes a fixed portion whose flexibility is lowered by mounting the reinforcing boards and a movable portion other than the fixed portion and the flexible optical interconnection board is fixed on the fixed portions.

### CROSS-REFERENCE TO RELATED APPLICATIONS

This application is based upon and claims the benefit of priority from prior Japanese Patent Application No. 2010-184120, filed Aug. 19, 2010, the entire contents of which are incorporated herein by reference.

### FIELD

Embodiments described herein relate generally to a flexible optoelectronic interconnection board capable of making optical signal transmission and electrical signal transmission and a flexible optoelectronic interconnection module having an optical semiconductor element mounted on the flexible optoelectronic interconnection board.

### BACKGROUND

Recently, in mobile communication devices such as personal computers and mobile phones, it is strongly required to increase the operation speed and reduce noise in signal transmission between a signal processing processor and a display. Therefore, much attention is paid to an optoelectronic interconnection in which electrical wires and an optical interconnection capable of making signal transmission with high speed and low noise are combined.

Particularly, in a general mobile communication device, since a main body-side casing having a signal processing processor received therein is connected to a display-side casing having a display received therein by means of a hinge that is a mobile component, an optoelectronic interconnection medium is required to have flexibility. As the optoelectronic interconnection medium having flexibility, for example, a flexible optoelectronic interconnection board on which a flexible optical interconnection board having optical interconnection lines formed on a flexible electrical wiring board having electrical wires is mounted and a flexible optoelectronic interconnection module having an optical semiconductor element mounted on the flexible optoelectronic interconnection board are provided.

### BRIEF DESCRIPTION OF THE DRAWINGS

FIGS. 1A and 1B are top and rear views showing the schematic structure of a flexible optoelectronic interconnection board according to a first embodiment.

FIG. 2 is a cross-sectional view showing an enlarged part of the schematic structure of the flexible optoelectronic interconnection board of the first embodiment.

FIGS. 3A and 3B are top and rear views showing the schematic structure of a flexible optoelectronic interconnection board according to a second embodiment.

FIGS. 4A and 4B are top and rear views showing the schematic structure of a flexible optoelectronic interconnection module according to a third embodiment.

FIG. 5 is a cross-sectional view showing an enlarged part of the schematic structure of the flexible optoelectronic interconnection module of the third embodiment.

### DETAILED DESCRIPTION

In general, according to one embodiment, a flexible optoelectronic interconnection board includes a flexible electrical wiring board having electrical wires, reinforcing boards mounted on the flexible electrical wiring board and having flexibility lower than that of the flexible electrical wiring board, and a flexible optical interconnection board mounted on the flexible electrical wiring board and having optical interconnection lines. The flexible electrical wiring board includes a fixed portion whose flexibility is lowered by mounting the reinforcing boards and a movable portion other than the fixed portions and the flexible optical interconnection board is fixed on the fixed portions.

In the following description, embodiments are explained with reference to the drawings. In this case, the explanation is made by using several concrete materials and constituents as an example, but if other materials and constituents having the same functions are used, the same operation can be performed and this invention is not limited to the following embodiments.

### First Embodiment

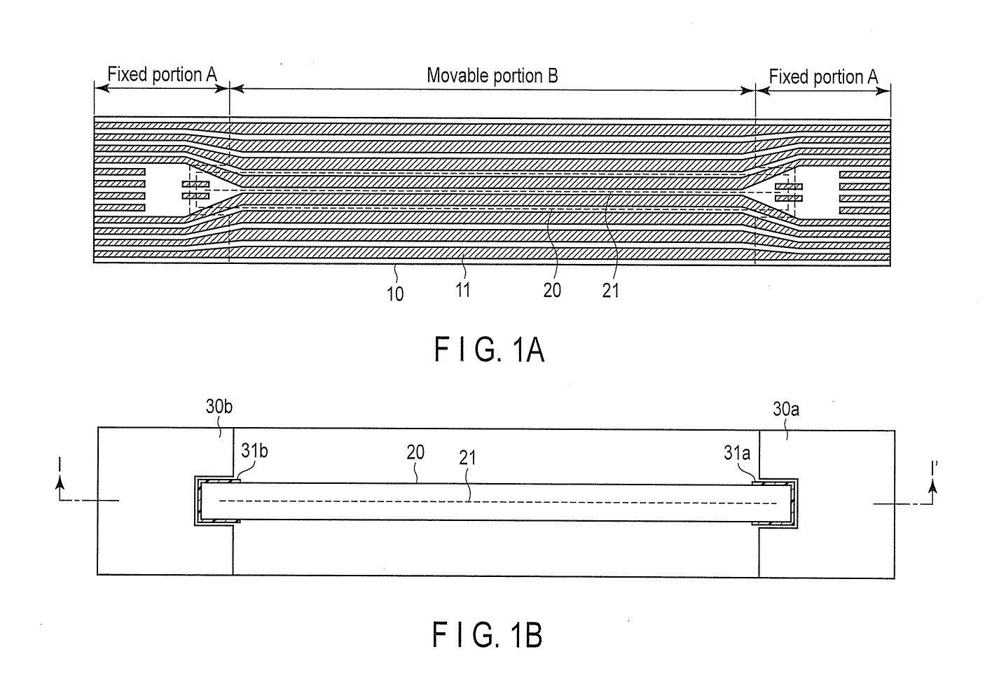

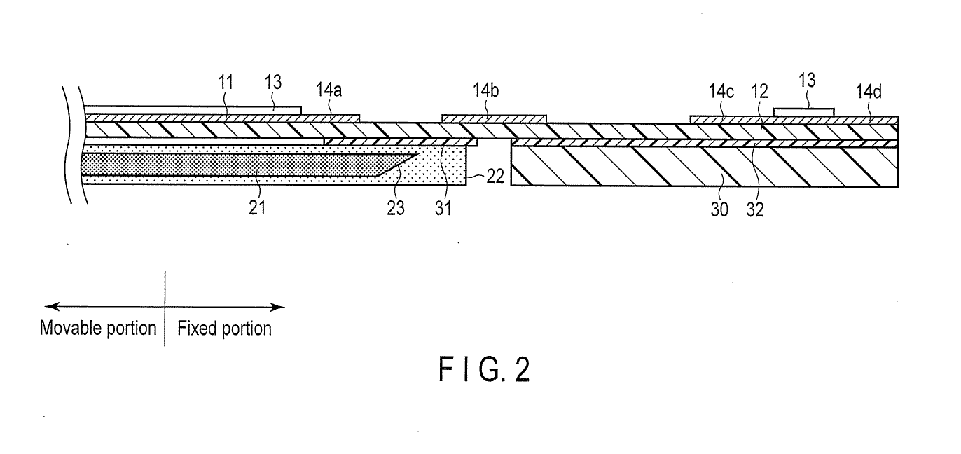

FIGS. 1A and 1B and FIG. 2 illustrate the schematic structure of a flexible optoelectronic interconnection board according to a first embodiment, FIG. 1A being a top view of the flexible optoelectronic interconnection board, FIG. 1B being a rear view of the flexible optoelectronic interconnection board and FIG. 2 being an enlarged cross-sectional view (a cross-sectional view taken along line I-I′ of FIG. 1B) showing a portion near one end of the flexible optoelectronic interconnection board. In FIGS. 1A and 1B and FIG. 2, only the main portion of the flexible optoelectronic interconnection board is shown and symbols are attached to the respective portions.

In FIGS. 1A and 1B, a symbol 10 denotes a flexible electrical wiring board, 11 electrical wires of the flexible electrical wiring board 10, 20 a flexible optical interconnection board, 21 an optical interconnection line (optical waveguide core) of the flexible optical interconnection board 20, 30 (30a, 30b) reinforcing boards and 31 (31a, 31b) adhesive sheets used for mounting the flexible optical interconnection board 20 on the flexible electrical wiring board 10.

In FIG. 2, a symbol 12 denotes a base film that is a supporting member for the flexible electrical wiring board 10, 13 cover layers that protect the surface of the flexible electrical wiring board 10, 14 (14a, 14b, 14c, 14d) electrical connection terminals for electrically connecting the electrical wrings 11 to the exterior, 22 an optical waveguide clad of the flexible optical interconnection board 20, 23 a 45° mirror formed on the end portion of the waveguide core 21 and 32 an adhesive sheet used for mounting the reinforcing board 30 on the flexible electrical wiring board 10.

The flexible electrical wiring board 10 has flexibility and includes the electrical wirings 11, base film 12 and cover layers 13. The electrical wire 11 is a Cu foil (for example, a rolled Cu foil, thickness 12 μm), the base film 12 is a polyimide film (for example, thickness 25 μm) and the cover layer 13 is a polyimide film (for example, thickness 25 μm), for example. The flexible electrical wiring board 10 has a laminated structure configured by laminating and bonding the above films and, for example, the width thereof is 10 mm and the length is 150 mm. As the electrical wire 11, the base film 12 integrally formed with a Cu foil via an adhesive layer or the base film 12 to which a Cu foil whose surface is made coarse is directly bonded by thermocompression may be used. The electrical wire 11 is formed by patterning a Cu foil laminated on the surface of the base film 12 and portions thereof are plated with Ni/Au (for example, thickness 5 μm/0.05 μm), for example, and used as the electrical connection terminals 14. The number of and the patterning shapes of the electrical wires 11 and electrical connection terminals 14 can be properly changed as required.

For example, the reinforcing board 30 is a polyimide film with the thickness of 125 μm, for example, that is thicker than the flexible electrical wiring board 10 and lower in flexibility than the flexible electrical wiring board 10. As the reinforcing board 30, for example, polyethylene terephtalate (PET) resin containing glass fiber may be used. Since the PET resin containing glass fiber has higher rigidity than a polyimide film with the same thickness, the same flexibility as that of the reinforcing board using the polyimide film can be achieved with the reduced thickness.

Further, the reinforcing boards 30 are mounted on the rear surfaces of one-side end portion and the other-side end portion of the flexible electrical wiring board 10 and adhered to the base film 12 via the adhesive sheets 32. The reinforcing boards 30 have concave portions that are recessed towards the end portions of the flexible electrical wiring board 10 and respectively formed in the end portion and the opposite end portion of the flexible electrical wiring board 10.

For example, the adhesive sheet 32 is formed by processing an adhesive formed of epoxy-series resin in a sheet form and has the thickness of 20 μm, for example. As the adhesive sheet 32, for example, an adhesive formed of acryl-series resin and processed in a sheet form may be used or a sheet obtained by coating adhesives formed of epoxy-series resin or acryl-series resin on both surfaces of a base plate formed of a polyimide film may be used.

As shown in FIG. 1A and FIG. 2, the flexible electrical wiring board 10 includes fixed portions A whose flexibility is lowered by mounting the reinforcing boards 30 and movable portion B sandwiched between fixed portions A. Since regions (corresponding to regions on which the adhesive sheets 31a and 31b are mounted in FIG. 1B) on which the reinforcing boards 30 are not directly mounted but each of which is surrounded in three directions by the reinforcing board 30 are inhibited from being bent in all directions by means of the reinforcing boards 30 and the flexibility thereof is lowered, the regions are contained in fixed portions A.

The flexible optical interconnection board 20 has flexibility and includes an optical interconnection line (optical waveguide core) 21 and optical waveguide clad 22. The optical waveguide core 21 and optical waveguide clad 22 are formed of a material (for example, acryl-series resin or epoxy-series resin) that is transparent with respect to the optical transmission wavelength (for example, 850 nm) and the refractive index of the optical waveguide core 21 is higher than that of the optical waveguide clad 22. As a result, light incident on the optical waveguide core 21 is confined in the optical waveguide clad 22 and propagates therein. The thickness of the optical waveguide core 21 is 30 μm and the thickness of the optical waveguide clad 22 is 50 μm, for example. The flexible optical interconnection board 20 is 1 mm in width and 130 mm in length, for example.

The cost of the flexible optoelectronic interconnection board is higher by an amount corresponding to at least the flexible optical interconnection board in comparison with the flexible electrical wiring board with the same size. Therefore, in the flexible optoelectronic interconnection board of this embodiment, the flexible electrical wiring board 10 and flexible optical interconnection board 20 are separately formed and the size of the flexible optical interconnection board 20 is kept to a minimum necessary value (the width is 1 mm in this embodiment). Thus, for example, the cost of the flexible optoelectronic interconnection board of this embodiment can be reduced in comparison with that of a flexible optoelectronic interconnection board in which an optoelectronic integrated flexible electrical wiring board is obtained by forming an optical interconnection layer on the entire surface of the flexible electrical wiring board 10 by a laminate process or the like or an optoelectronic integrated flexible optoelectronic interconnection board with the same size as the flexible optical interconnection board 20 is mounted on the flexible electrical wiring board 10.

In the flexible optoelectronic interconnection board of this embodiment, the width of each optical waveguide core 21 of the flexible optical interconnection board 20 is 30 μm and an optical signal can be transmitted with 10 Gbps, for example, for each core. For example, if four optical waveguide cores are formed in the flexible optical interconnection board 20 of the width of 1 mm at a pitch of 250 μm, high-speed signal transmission of 40 Gpbs can be performed. In an electrical wire (for example, an electrical wire used for analog signal transmission or supply of electric power) that does not require optical transmission or in which optical transmission is difficult, the electrical wire 11 of the flexible electrical wiring board 10 can be used.

The flexible optical interconnection board 20 can be formed as follows, for example, by using an adhesive formed of acryl-series resin that can be re-separated on a base member formed of PET resin, for example, as a carrier tape. That is, after a first optical waveguide clad and optical waveguide core are sequentially laminated on the carrier tape, the optical waveguide core is patterned. Then, a second optical waveguide clad is laminated on the patterned optical waveguide core and then the first waveguide clad is separated from the carrier tape. The optical waveguide core 21 can be formed by pattern exposure to an optical waveguide film if resin whose refractive index is changed when exposed is used as the optical waveguide film.

At both ends of the optical waveguide core 21, the 45° mirrors 23 are disposed. By the presence of the 45° mirrors 23, light propagating along the optical waveguide core 21 can be taken out in a direction substantially perpendicular to the surface of the flexible optical interconnection board 20 and light incident in a direction substantially perpendicular to the surface of the flexible optical interconnection board 20 can be coupled with the optical waveguide core 21. For example, the 45° mirror 23 can be formed by laser application, dicing, molding formation or the like and metal (for example, Au) may be vapor-deposited on the mirror surface for enhancing the refractive index.

By forming the 45° mirrors 23 and vapor-depositing metal on the mirror surfaces before laminating the second optical waveguide clad, the 45° mirrors 23 can be embedded in the optical waveguide clad 22. Therefore, in the 45° mirror 23, the refractive index can be kept from being lowered due to stress strain and moisture absorption and the reliability can be enhanced. The angle (an angle with respect to the light propagation direction) of the 45° mirror 23 may not be necessarily exactly set at 45°. In practice, it is preferable to set the angle in a range of 40 to 50°.

The flexible optical interconnection board 20 is adhered to the rear surface of the flexible electrical wiring board 10 in portions in which the 45° mirrors 23 are formed near the both end portions thereof by means of the adhesive sheets 31 (for example, that are obtained by processing an adhesive formed of epoxy-series resin on a sheet and whose thickness is 20 μm). Therefore, an optical signal propagating along the optical waveguide core 21 is reflected on the 45° mirror 23, passes through the adhesive sheet 31 and base film 12 and taken out on the main surface side (the upper surface side in FIG. 2) of the flexible optoelectronic interconnection board. Further, an optical signal that passes through the base film 12 and adhesive sheet 31 from the main surface side of the flexible optoelectronic interconnection board and is reflected on the 45° mirror 23 is coupled with the optical waveguide core 21 and propagates. As a result, as will be described later, optical signal transmission can be performed between optical semiconductor elements mounted near the both end portions of the flexible optoelectronic interconnection board.

The adhesive sheet 31 and base film 12 may be desirably formed of a material (for example, acryl-series resin or epoxy-series resin) that is transparent with respect to the optical transmission wavelength. However, since the adhesive sheet 31 and base film 12 are thin (in this example, the thickness of the adhesive sheet 31 is 20 μm and the thickness of the base film 12 is 25 μm), a material having an absorption property with respect to the optical transmission wavelength of polyimide-series resin, for example, may be used when the absolute amount of optical loss is small (for example, the amount of optical loss is 5%). As the adhesive sheet 31, the same material as the adhesive sheet 32 may be used or a different material can be used.

The flexible optical interconnection board 20 is mounted in alignment with the flexible electrical wiring board 10. This can be realized by using the 45° mirror 23 of the flexible optical interconnection board 20 and the electrical wires 11 of the flexible electrical wiring board 10 as a mark for alignment. Thus, high optical coupling efficiency can be realized by setting the light-emitting portion or light-receiving portion of the optical semiconductor element to face the 45° mirror 23 of the flexible optical interconnection board 20 when the optical semiconductor element is mounted on the flexible electrical wiring board 10 of the flexible optoelectronic interconnection board later.

In this case, portions of the flexible optical interconnection board 20 in which the 45° mirrors 23 lying near the both ends thereof are formed are mounted in fixed portions A of the flexible electrical wiring board 10. Therefore, the optical coupling passage between the optical waveguide core 21 and the exterior of the optical waveguide core 21 (for example, the optical semiconductor element mounted on the flexible electrical wiring board 10 of the flexible optoelectronic interconnection board later) or the base film 12, adhesive sheet 31, optical waveguide clad 22 and 45° mirrors 23 used as the optical coupling portion are difficult to be deformed or damaged when they are assembled and carried or incorporated in a device and used (movable portion B is bent). As the deformation or damage, for example, separation of the adhesive sheet 31 from the flexible electrical wiring board 10 or flexible optical interconnection board 20, stress strain of the base film 12, adhesive sheet 31 or optical waveguide clad 22 or separation of an Au vapor-deposition film formed on the 45° mirror 23 and the like are provided.

In the flexible optoelectronic interconnection board of this embodiment, the optical coupling efficiency between the optical waveguide core 21 and the exterior of the optical waveguide core 21 can be prevented from being degraded and the reliability of the flexible optoelectronic interconnection board can be enhanced.

Thus, according to this embodiment, the costs of the respective members can be lowered by separately forming the flexible electrical wiring board 10 and flexible optical interconnection board 20 and keeping the size of the flexible optical interconnection board 20 to a minimum. Additionally, the optical coupling efficiency between the optical waveguide core 21 and the exterior of the optical waveguide core 21 can be prevented from being degraded and the reliability of the flexible optoelectronic interconnection board can be enhanced by mounting the forming portions of the 45° mirrors 23 of the flexible optical interconnection board 20 on fixed portions A of the flexible electrical wiring board 10.

Since the reinforcing board 30 is formed thicker than the flexible optical interconnection board 20, the flexible optical interconnection board 20 will not be made contact with a physical body when the flexible optoelectronic interconnection board is placed on the physical body with the rear surface down. Therefore, the flexible optical interconnection board 20 can be protected. Further, since the flexible optical interconnection board 20 is not adhered to movable portion B of the flexible electrical wiring board 10, the flexible optoelectronic interconnection board of this embodiment has an advantage that flexibility can be maintained and the board can be easily bent.

### Second Embodiment

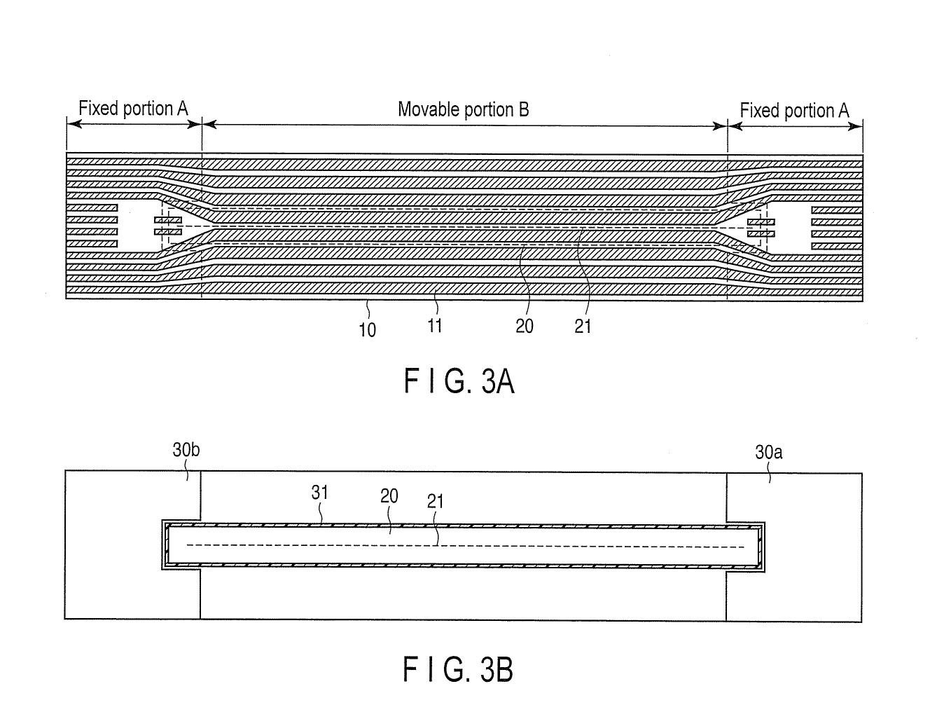

FIGS. 3A and 3B are views showing the schematic structure of a flexible optoelectronic interconnection board according to a second embodiment that is different from the first embodiment of FIGS. 1A and 1B in that a flexible optical interconnection board is mounted on a flexible electrical wiring board also in movable portion B. FIG. 3A is a top view of the flexible optoelectronic interconnection board, FIG. 3B is a rear view of the flexible optoelectronic interconnection board and portions that are the same as those of FIGS. 1A and 1B are denoted by the same symbols and the detailed explanation thereof is omitted.

In this embodiment, a flexible optical interconnection board 20 is adhered to a flexible electrical wiring board 10 also in movable portion B of the flexible electrical wiring board 10 via an adhesive sheet 31. Thus, the mounting area between the flexible electrical wiring board 10 and the flexible optical interconnection board 20 is increased to more strongly connect them and effectively suppress misalignment between electrical wires 11 and 45° mirrors 23. Therefore, when an optical semiconductor element is mounted later, the efficiency of optical coupling between the optical semiconductor element and an optical interconnection line 21 can be prevented from being degraded and the reliability of the flexible optoelectronic interconnection board can be enhanced.

In this embodiment, in an area in which the flexible optical interconnection board 20 is mounted on the flexible electrical wiring board 10 in movable portion B, the electrical wires 11 of the flexible electrical wiring board 10 and the optical interconnection line 21 of the flexible optical interconnection board 20 do not intersect with each other. Further, the optical waveguide core 21 is arranged not in a boundary region of the electrical wires 11 (the boundary between a region in which the electrical wires 11 are present and a region in which the electrical wires 11 are not present) but in a region that overlaps with the electrical wiring 11 or a region in which the electrical wires 11 are not present. In FIGS. 3A and 3B, a single optical waveguide core 21 is shown, but the number of cores is not limited to one and it is of course possible to provide a plurality of cores.

In this example, the electrical wire 11 formed of a metal material is less flexible than a surrounding material formed of a resin material (in this embodiment, a base film 12, adhesive sheet 31, optical waveguide clad 22, optical waveguide core 21). Therefore, in a case where movable portion B is deformed or bent when the wires are assembled, carried or incorporated in a device and used, stress tends to be concentrated in a portion near the boundary portion of the electrical wires 11. Further, since the electrical wire 11 formed of a metal material has the coefficient of thermal expansion lower than that of a surrounding material formed of a resin material, stress tends to be concentrated in a portion near the boundary portion of the electrical wires 11 at the time of temperature change.

When the flexible optical interconnection board 20 is mounted on the flexible electrical wiring board 10 in movable portion B via the adhesive sheet 31 and the electrical wires 11 intersect with the optical interconnection line 21, the boundary of the electrical wires 11 crosses the optical interconnection line 21. Therefore, there occurs a possibility that stress concentrated in a portion near the boundary portion of the electrical wires 11 at the deformation time or at the time of temperature change is easily transmitted to the optical interconnection line 21 to increase the optical loss in the optical interconnection line 21. However, in the flexible optoelectronic interconnection board of this embodiment, the flexible optical interconnection board 20 is mounted on the flexible electrical wiring board 10 in movable portion B via the adhesive sheet 31, but the electrical wires 11 do not intersect with the optical interconnection line 21 in movable portion B. Therefore, the boundary of the electrical wires 11 does not cross the optical interconnection line 21. As a result, stress concentrated in a portion near the boundary portion of the electrical wire 11 at the deformation time or at the time of temperature change is difficult to be transmitted to the optical interconnection line 21 and an increase in the optical loss in the optical interconnection line 21 can be prevented.

In the above example, a case wherein the flexible optical interconnection board 20 is adhered to the flexible electrical wiring board 10 via the adhesive sheet 31 in the entire movable portion of the flexible electrical wiring board 10 is explained. However, this embodiment is not limited to this case and the flexible optical interconnection board 20 may be mounted on the flexible electrical wiring board 10 only in a portion of movable portion B.

Thus, according to this embodiment, the positional deviation between the electrical wires 11 and the 45° mirrors 23 can be effectively suppressed by mounting the flexible optical interconnection board 20 on the flexible electrical wiring board 10 also in movable portion B. Further, in the region in which the flexible optical interconnection board 20 is mounted on the flexible electrical wiring board 10 in movable portion B, the electrical wires 11 of the flexible electrical wiring board 10 and the optical interconnection line 21 of the flexible optical interconnection board 20 do not intersect with each other. Therefore, an increase in the optical loss due to the deformation and bending of movable portion B and the temperature change can be prevented and the reliability of the flexible optoelectronic interconnection board can be enhanced.

### Third Embodiment

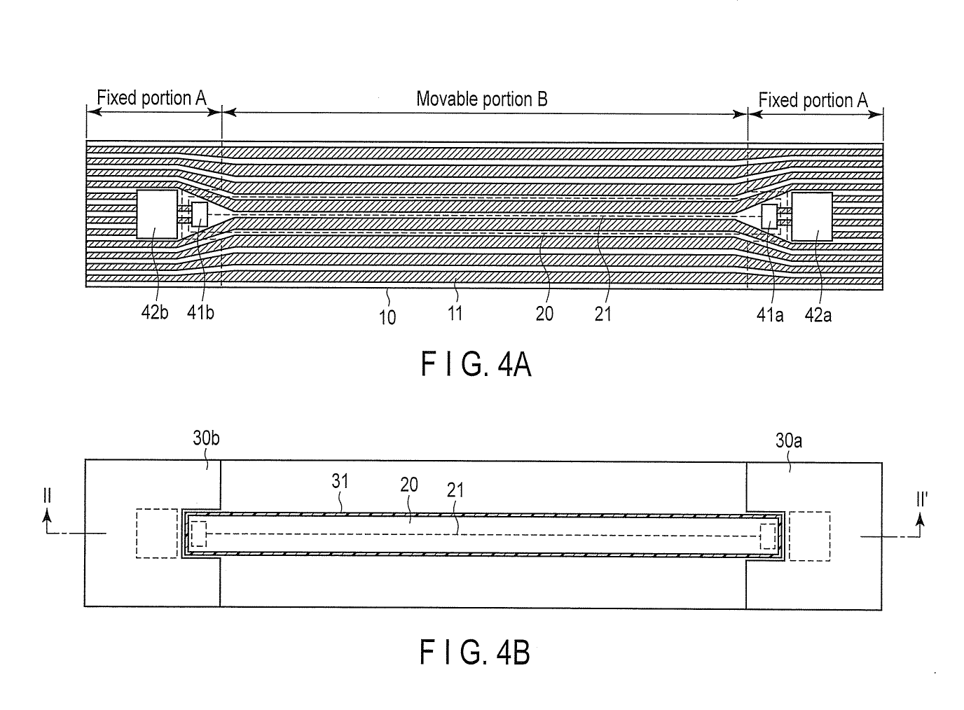

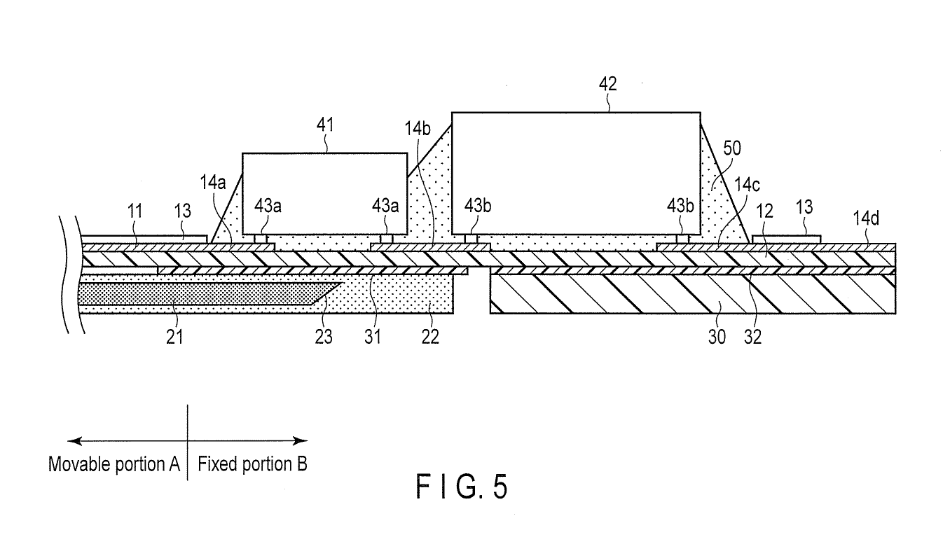

FIGS. 4A and 4B and FIG. 5 are views showing the schematic structure of a flexible optoelectronic interconnection module according to a third embodiment. This embodiment is different from the first embodiment in that optical semiconductor elements and drive ICs that drive the respective optical semiconductor elements are mounted on a flexible optoelectronic interconnection board. FIG. 4A is a top view of the flexible optoelectronic interconnection module, FIG. 4B is a rear view of the flexible optoelectronic interconnection module and FIG. 5 is a cross-sectional view of the flexible optoelectronic interconnection module in a portion near one end thereof (a cross-sectional view taken along line II-II′ of FIG. 4B). Portions that are the same as those of to FIGS. 1A, 1B to FIGS. 3A, 3B are denoted by the same symbols and the detailed explanation thereof is omitted.

In FIGS. 4A and 4B, a symbol 41a denotes an optical semiconductor element (light-emitting element), 41b an optical semiconductor element (light-receiving element), 42a a drive IC that drives the light-emitting element 41a and 42b a drive IC that drives the light-receiving element 41b and amplifies a received light current. Further, in FIG. 5, a symbol 43 (43a, 43b) denotes stud bumps that electrically connect the optical semiconductor element 41 and drive IC 42 to electrical wires 11 and 50 denotes under-fill resin that reinforces the connection between the optical semiconductor element 41 and drive IC 42 and a flexible electrical wiring board 10.

For example, it is assumed that a light-emitting element or light-receiving element formed on a GaAs substrate is used as the optical semiconductor element 41 and the light-emitting or light-receiving wavelength is set to 850 nm. For example, a surface emitting laser (vertical cavity surface emitting laser [VCSEL]) can be used as the light-emitting element and a PIN photodiode (PIN-PD) can be used as the light-receiving element. The optical semiconductor element 41 may be formed on a substrate of compound semiconductor (for example, GaAlAs/GaAs, InGaAs/InP, SiGe or the like), Si, Ge or the like. The light-emitting or light-receiving wavelength can be adequately changed as required. Further, as the optical semiconductor element 41, an array chip having a plurality of optical elements formed in one chip may be used and an optical semiconductor element having both of light-emitting and light-receiving elements formed in one chip may be used. Further, an optical semiconductor element having one element that can attain both of light-emitting and light-receiving functions can be used.

The optical semiconductor element 41 is aligned to set the light-emitting portion or light-receiving portion to face the 45° mirror 23 formed on the optical waveguide core 21 and is mounted on the electrical wires 11 of the flexible electrical wiring board 10 by use of a ultrasonic flip-chip mounting method, for example. As a result, the light-emitting element 41a mounted on one end portion of the optical waveguide core 21 and the light-receiving element 41b mounted on the other end portion are optically coupled with each other via the optical waveguide core 21 and optical signal transmission between one end side and the other end side of the flexible optoelectronic interconnection module can be performed. Further, for example, the optical semiconductor element 41 is electrically connected to the electrical wires 11 via the stud bumps 43a formed of Au wires, and therefore, optical signal transmission can be performed based on electrical input/output. As another method for electrical connection between the optical semiconductor element 41 and the electrical wires 11, for example, bump connection by using solder bumps, wire bonding connection and the like can be used.

For example, the under-fill resin 50 is formed of epoxy-series resin and is coated on the bottom surface and side surfaces of the optical semiconductor element 41 and cured by heating, application of ultraviolet rays or the like. Electrical connection between the optical semiconductor element 41 and the electrical wires 11 can be maintained with high reliability by forming the under-fill resin 50. At this time, a gap between the optical semiconductor element 41 and the optical waveguide core 21 can be filled to suppress reflection of light on the interface between the gap and the optical semiconductor element 41 or optical waveguide core 21 and increase the optical coupling efficiency. As a result, highly efficient and highly reliable optical coupling can be achieved.

The under-fill resin used to fill the gap between the optical semiconductor element 41 and the optical waveguide core 21 and the under-fill resin used to maintain electrical connection between the optical semiconductor element 41 and the electrical wires 11 are not necessarily formed of the same material and may be formed of different materials. In either case, the under-fill resin used to fill the gap between the optical semiconductor element 41 and the optical waveguide core 21 may be desirably transparent with respect to the optical transmission wavelength.

The optical semiconductor element 41 is mounted on the electrical wires 11 in fixed portions A of the flexible electrical wiring board 10. As a result, deformation or damage is difficult to occur in the under-fill resin 50, base film 12, adhesive sheet 31, optical waveguide clad 22 and 45° mirror 23 that configure the optical coupling portion or the optical coupling passage between the optical semiconductor element 41 and the optical interconnection line 21 when they are assembled and carried or incorporated in a device and used (movable portion B is bent). As the deformation or damage, for example, separation of the under-fill resin 50 from the optical semiconductor element 41 or base film 12, separation of the adhesive sheet 31 from the flexible electrical wiring board 10 or flexible optical interconnection board 20, stress strain of the under-fill resin 50, base film 12, adhesive sheet 31 or optical waveguide clad 22 or separation of the Au vapor-deposition film and the like are provided.

Thus, in the flexible optoelectronic interconnection module of this embodiment, the efficiency of optical coupling between the optical semiconductor element 41 and the optical waveguide core 21 can be prevented from being degraded and the reliability of the flexible optoelectronic interconnection module can be enhanced.

In the flexible optoelectronic interconnection module of this embodiment, the drive IC 42 (42a, 42b) is further mounted. The drive IC 42 is mounted on a surface opposite to a portion on which a highly rigid reinforcing board 30 for the flexible electrical wiring board 10 in fixed portion A of the flexible electrical wiring board 10 by using an ultrasonic flip-chip mounting method, for example. Therefore, a highly rigid electrical connection can be realized for the electrical wires 11 of the flexible electrical wiring board 10. Further, the under-fill resin 50 is coated on the bottom surface and side surfaces of the drive IC 42 to maintain the electrical connection between the drive IC 42 and the electrical wires 11 with high reliability.

The drive IC 42a can supply a bias current and drive current to the light-emitting element 41a and the drive IC 42b can apply a reverse bias voltage to the light-receiving element 41b and amplify the light-receiving current. The distance between the drive IC 42 and the optical semiconductor element 41 is reduced by mounting the drive IC 42 on the flexible optoelectronic interconnection module. Therefore, the degradation of a signal due to the wiring resistance and wiring capacitance and the influence by noise with respect to an analog signal transferred between the drive IC 42 and the optical semiconductor element 41 can be kept to a minimum and high-quality signal transmission can be achieved.

In the drive IC 42, an input/output signal with respect to the exterior is desirably a digital signal. Like the optical semiconductor element 41, the drive IC 42 is electrically connected to the electrical wires 11 of the flexible electrical wiring board 10 via the stud bumps 43. As a result, a flexible optoelectronic interconnection module having a digital electrical signal input/output interface can be realized.

In FIGS. 4A and 4B, one light-emitting element 41a is mounted on one end side of the flexible optoelectronic interconnection board and one light-receiving element 41b is mounted on the other end side, but still another optical semiconductor element may be mounted. In FIG. 4A, the optical signal transmission direction is set to a single direction from one end side to the other end side of the flexible optoelectronic interconnection board, but optical signal transmission may be performed in a direction opposite to that of FIG. 4A by mounting a light-receiving element on one end side and mounting a light-emitting element on the other end side. Further, bidirectional optical signal transmission may be performed by mounting light-emitting and light-receiving elements on one end side and mounting light-receiving and light-emitting elements on the other end side.

The drive IC 42 may have a transceiver function of driving both of the light-emitting element 41a and light-receiving element 41b. Further, for example, the drive IC may have a different circuit function such as a serialize function of converting a parallel electrical signal to a serial electrical signal or a de-serialize function of converting a serial electrical signal to a parallel electrical signal. If the serialize function is provided on the drive IC 42a for the light-emitting element 41a and the de-serialize function is provided on the drive IC 42b for the light-receiving element 41b, a plurality of electrical input signals can be converted into a less number of optical signals and transmitted.

Thus, according to this embodiment, the optical semiconductor element 41 and drive IC 42 are mounted on the flexible optoelectronic interconnection board of low cost. Therefore, it is possible to realize a flexible optoelectronic interconnection module in which the cost can of course be kept low, the degradation in the efficiency of optical coupling between the optical semiconductor element 41 and the optical interconnection line 21 can be prevented by mounting the optical semiconductor elements 41 on fixed portions A of the flexible electrical wiring board 10 and the reliability with respect to bending or deformation can be enhanced.

In this embodiment, the flexible optical interconnection board 20 is mounted on the flexible electrical wiring board 10 in the entire movable portion of the flexible electrical wiring board 10. However, this embodiment is not limited to this case and the flexible optical interconnection board 20 may be mounted on the flexible electrical wiring board 10 only in a part of movable portion B of the flexible electrical wiring board 10 or may not be mounted on the flexible electrical wiring board 10 in movable portion B of the flexible electrical wiring board 10.

(Modification)

This invention is not limited to the above embodiments.

As the light-emitting element that is an optical semiconductor element, various light-emitting elements such as a light-emitting diode or semiconductor laser can be used. As the light-receiving element that is an optical semiconductor element, various light-receiving elements such as a PIN photodiode, MSM photodiode, avalanche photodiode or photoconductor can be used. As the flexible electrical wiring board, a flexible printed circuit (FPC) and flexible flat cable (FFC) are provided and any one of them can be used in this invention. As the base film of the flexible electrical wiring board, liquid crystal polymer or other resin can be used in addition to polyimide. The electrical wires of the flexible electrical wiring board can be formed in a single-layered form or multi-layered form. Further, the optical interconnection of the flexible optical interconnection board can be formed in a single-layered form or multi-layered form.

Further, in this embodiment, the electrical wires are formed on the surface of the flexible electrical wiring board and the flexible optical interconnection board and reinforcing board are mounted on the rear surface of the flexible electrical wiring board. However, the flexible optical interconnection board and reinforcing board can be mounted on the same surface as the electrical wires. Further, the flexible optical interconnection board and reinforcing board are not necessarily mounted by means of an adhesive and may be mounted by use of a thermocompression bonding method or another method. Further, the reinforcing members are provided on both end sides of the flexible electrical wiring board, but can be provided on one end side. Additionally, when the interconnection line is branched on the way, the reinforcing member can be provided on each branched end.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A flexible optoelectronic interconnection board comprising:
a flexible electrical wiring board including electrical wires,
reinforcing boards mounted on the flexible electrical wiring board and having flexibility lower than that of the flexible electrical wiring board, and
a flexible optical interconnection board mounted on the flexible electrical wiring board and including an optical interconnection line,
wherein the flexible electrical wiring board includes fixed portions whose flexibility is lowered by mounting the reinforcing boards and a movable portion other than the fixed portions and the flexible optical interconnection board is fixed on the fixed portions.

2. The optoelectronic interconnection board of claim 1, wherein the flexible optical interconnection board includes a mirror that changes an optical pass at positions near both ends of the optical interconnection line, and the mirror is located in a part fixed to the fixed positions of the flexible optical interconnection board.

3. The optoelectronic interconnection board of claim 1, wherein the flexible optical interconnection board is fixed on a portion of the movable portion together with the fixed portions and the electrical wires and the optical interconnection line do not intersect with each other in a portion in which the flexible optical interconnection board is fixed on the movable portion.

4. The optoelectronic interconnection board of claim 1, wherein the flexible electrical wiring board includes the electrical wires on a front surface side thereof and the reinforcing boards and flexible optical interconnection board are mounted on a rear surface side of the flexible electrical wiring board.

5. The optoelectronic interconnection board of claim 4, wherein the reinforcing boards are fixed on one end portion and the other end portion of the flexible electrical wiring board and have concave portions recessed towards the end portions of the flexible electrical wiring board in portions of the reinforcing boards on one end side and the other end side of the flexible electrical wiring board, and the flexible optical interconnection board is fixed in the concave portions without overlapping the reinforcing boards.

6. The optoelectronic interconnection board of claim 1, wherein the reinforcing board is made thicker than the flexible optical interconnection board.

7. The optoelectronic interconnection board of claim 1, wherein the reinforcing boards and flexible optical interconnection board are adhered to the flexible electrical wiring board by means of adhesive sheets.

8. A flexible optoelectronic interconnection board comprising:
a flexible electrical wiring board including electrical wires formed on a front surface side,
reinforcing boards mounted on both end portions on a rear surface side of the flexible electrical wiring board and having flexibility lower than that of the flexible electrical wiring board, and
a flexible optical interconnection board mounted on the rear surface side of the flexible electrical wiring board and including an optical interconnection line,
wherein the flexible electrical wiring board includes fixed portions whose flexibility is lowered by mounting the reinforcing boards and a movable portion between the fixed portions and both ends of the flexible optical interconnection board are fixed on the fixed portions.

9. The optoelectronic interconnection board of claim 8, wherein the flexible optical interconnection board is fixed on a portion of the movable portion together with the fixed portions and the electrical wires and the optical interconnection line do not intersect with each other in a portion in which the flexible optical interconnection board is fixed on the movable portion.

10. The optoelectronic interconnection board of claim 8, wherein the reinforcing boards have concave portions recessed towards the end portions of the flexible electrical wiring board in portions of one end side and the other end side of the flexible electrical wiring board, and the flexible optical interconnection board is fixed in the concave portions without overlapping the reinforcing boards.

11. The optoelectronic interconnection board of claim 8, wherein the reinforcing board is made thicker than the flexible optical interconnection board.

12. The optoelectronic interconnection board of claim 8, wherein the reinforcing boards and flexible optical interconnection board are adhered to the flexible electrical wiring board by means of adhesive sheets.

13. A flexible optoelectronic interconnection module comprising:
a flexible electrical wiring board including electrical wires,
reinforcing boards mounted on the flexible electrical wiring board and having flexibility lower than that of the flexible electrical wiring board,
a flexible optical interconnection board mounted on the flexible electrical wiring board and including optical interconnection lines, the flexible optical interconnection board being fixed on the fixed portions of the flexible electrical wiring board whose flexibility is lowered by mounting the reinforcing boards, and
optical semiconductor elements mounted on the fixed portions of the flexible electrical wiring board and optically coupled with the optical interconnection line of the flexible optical interconnection board.

14. The module of claim 13, wherein the optical semiconductor elements are located in a part fixed to the fixed positions of the flexible optical interconnection board.

15. The module of claim 14, further comprising drive ICs mounted on the fixed portions of the flexible electrical wiring board and provided for driving the optical semiconductor elements.

16. The module of claim 14, wherein the flexible optical interconnection board is fixed on a portion of the movable portion together with the fixed portions and the electrical wires and the optical interconnection line do not intersect with each other in a portion in which the flexible optical interconnection board is fixed on the movable portion.

17. The module of claim 14, wherein the flexible electrical wiring board includes the electrical wires on a front surface side thereof and the reinforcing boards and flexible optical interconnection board are mounted on a rear surface side of the flexible electrical wiring board.

18. The module of claim 17, wherein the reinforcing boards are fixed on one end portion and the other end portion of the flexible electrical wiring board and have concave portions recessed towards the end portions of the flexible electrical wiring board in portions of the reinforcing boards on one end side and the other end side of the flexible electrical wiring board, and the flexible optical interconnection board is fixed in the concave portions without overlapping the reinforcing boards.

19. The module of claim 14, wherein the reinforcing board is made thicker than the flexible optical interconnection board.

20. The module of claim 14, wherein the reinforcing boards and flexible optical interconnection board are adhered to the flexible electrical wiring board by means of adhesive sheets.
